(19) United States
(12) Patent Application Publication
(10) Pub. No.: US 2014/0368678 A1
(43) Pub. Date: Dec. 18, 2014

(54) REMOTE GUIDING SYSTEM, GUIDING TERMINAL AND SEEKING HELP TERMINAL

(71) Applicant: HON HAI PRECISION INDUSTRY CO., LTD., New Taipei (TW)

(72) Inventors: SHIH-CHENG WANG, New Taipei (TW); YI-WEN CAI, New Taipei (TW)

(21) Appl. No.: 14/304,993

(22) Filed: Jun. 16, 2014

(30) Foreign Application Priority Data
Jun. 17, 2013 (TW) 102121350

(51) Int. Cl. H04N 5/232

(52) U.S. Cl. CPC H04N 5/23203; H04N 5/23293
USPC 348/211.1

(57) ABSTRACT

A guiding terminal to assist non-professionals at the scene of a disaster or other emergency includes a transmission module, a projecting module, a photo module and a photo identification module. The transmitting module communicates with a seeking help terminal. The projecting module projects pictures transmitted from the seeking help terminal to a displaying object. The photo module captures pictures of a guiding action. The photo identification module identifies the guiding action to obtain a position to which the guiding action is pointing and generates a guiding information according to the position. The transmission module further transmits the guiding information to the seeking help terminal. The invention also provides a remote guiding system and a seeking help terminal.

### BACKGROUND

1. Technical Field

The present disclosure relates to a remote guiding system, a guiding terminal and a seeking help terminal.

2. Description of the Related Art

When an emergency (e.g., fire) happens, strangers are usually the only persons in the vicinity of the emergency. The strangers generally have no corresponding professional knowledge and can not deal with the scene of the emergency.

### BRIEF DESCRIPTION OF THE DRAWING

The disclosure is illustrated by way of example and not by way of limitation in the figures of the accompanying drawings in which like references indicate similar elements.

FIG. 1 is a diagram block of a remote guiding system, according to an exemplary embodiment.

FIG. 2 is a schematic view of the remote guiding system of FIG. 1 with the seeking help terminal transmitting images of the scene to the guiding terminal.

FIG. 3 is a schematic view of the remote guiding system of FIG. 1 with the guiding terminal transmitting guidance to the seeking help terminal.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

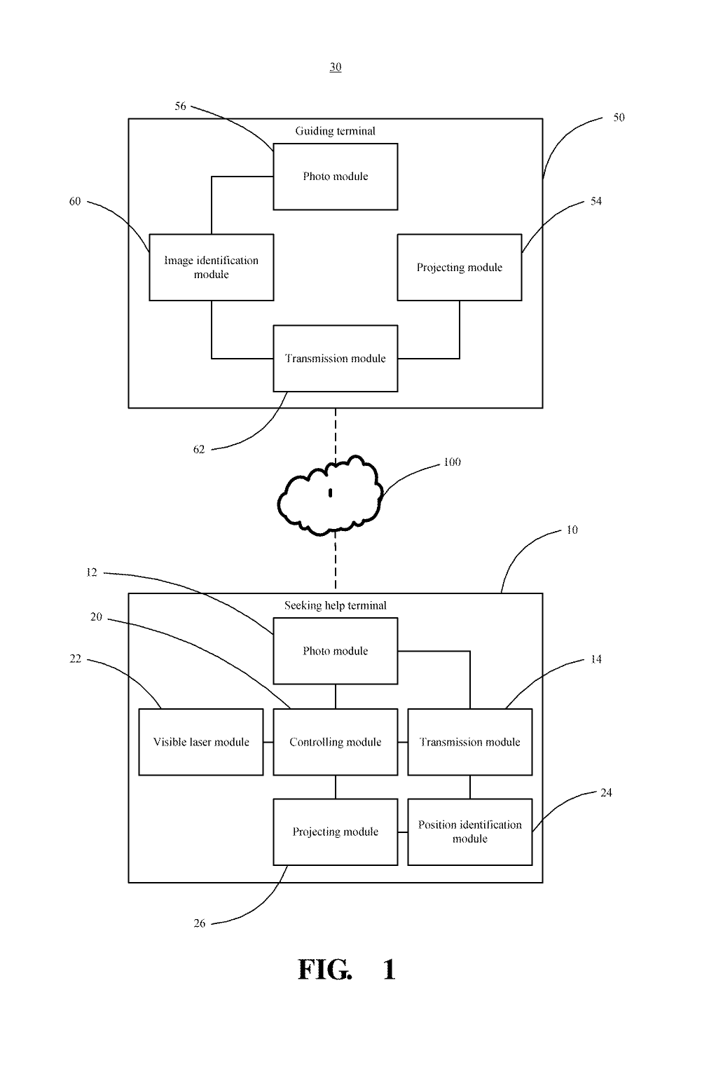

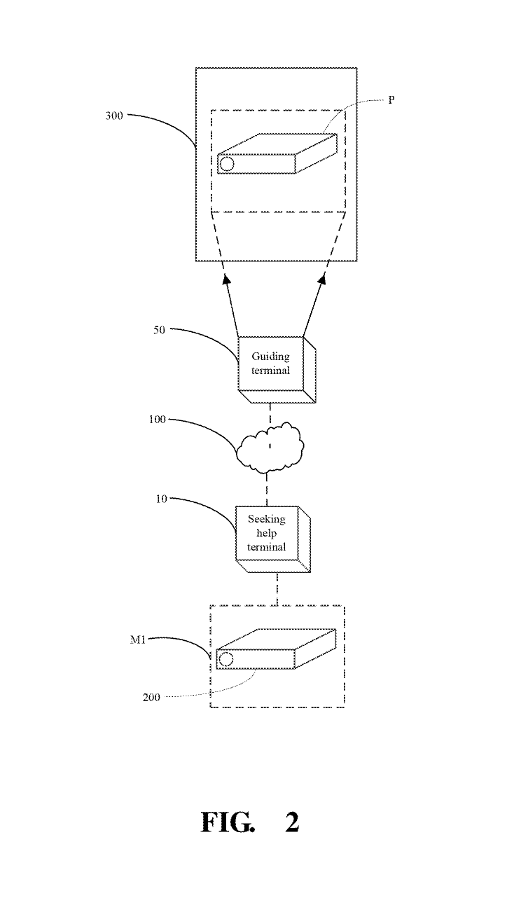

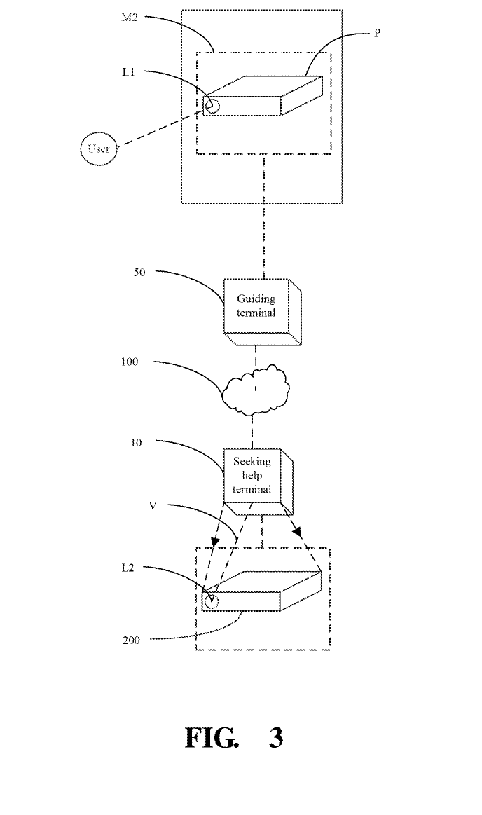

Referring to FIGS. 1-3, a remote guiding system 30 includes a guiding terminal 50 and a seeking help terminal 10. The guiding terminal 50 is in communication with the seeking help terminal 10 via a communication network 100. The guiding terminal 50 is configured to provide remote guidance. The seeking help terminal 10 is configured to receive the remote guidance. In the exemplary embodiment, the guiding terminal 50 and the seeking help terminal 10 are both portable electronic devices.

The seeking help terminal 10 includes a photo module 12, a transmission module 14, a controlling module 20, a visible laser module 22 and a projecting module 26. The photo module 12 is configured to capture an image M1 corresponding to an object 200 (e.g. a fire alarm control panel) in the vicinity of the seeking help terminal 10. The image M1 includes at least part of the object 200. In the exemplary embodiment, the image M1 is a picture of a video. The photo module 12 periodically captures image M1. The transmission module 14 is configured to communicate with the guiding terminal 50 and transmit the image M1 to the guiding terminal 50.

The guiding terminal 50 includes a projecting module 54, a photo module 56, an image identification module 60, and a transmission module 62. The projecting module 54 is configured to receive the images M1 and project the images M1 to an object 300 (e.g. a wall) in the vicinity of the guiding terminal 50. Therefore, a projected picture P corresponding to the object 200 is shown on the object 300. A user of the guiding terminal 50 sees the projected image P. The user of the guiding terminal 50 provides guidance on the projection picture P. The guidance includes a guiding action (e.g. press a button on a fire alarm control panel) carried out via a gesture of the user or indicated by a laser. The photo module 56 is configured to capture an image M2 corresponding to the guidance. The image M2 includes a picture of the guiding action. In the exemplary embodiment, the image M2 is a picture of a video. The photo module 56 periodically captures the images M2. The image identification module 60 is configured to identify the guiding action to obtain a position L1 to which the guiding action is pointing and generate a guiding information according to the position L1. The position L1 is located on the image M2. The transmission module 62 is configured to transmit the guiding information to the seeking help terminal 10.

In the exemplary embodiment, the image identification module 60 obtains a guiding picture from the image M2. The guiding picture includes the projected picture P. The guiding information includes the guiding picture and the position L1. The position L1 is represented by coordinates in the guiding picture.

The transmission module 14 of the seeking help terminal 10 is further configured to receive the guiding information. The controlling module 20 is configured to control the visible laser module 22 to project a visible laser on the object 200 according to the guiding information.

In the exemplary embodiment, after the photo module 10 of the seeking help terminal 10 captures a new image M1, the controlling module 20 obtains a current picture corresponding to the object 200 from the new image M1 and compares the current picture to the guiding picture of the guiding information to obtain a projected position L2 on the object 200. The projected position L2 corresponds to the position L1. The controlling module 20 controls the visible laser module 22 to highlight the projected position L2 on the object 200.

In the exemplary embodiment, the transmission module 14 of the seeking help terminal 10 further receives the image M2 from the guiding terminal 50. The projection module 26 is configured to project the image M2 on an object in the vicinity of the seeking help terminal 10 to be seen by a user.

In another exemplary embodiment, the guiding information only includes the position L1. The seeking help terminal 10 further includes a position identification module 24. The position identification module 24 is configured to identify a position of the seeking help terminal 10 and generate a position information corresponding to the position of the seeking help terminal 10. The position identification module 24 includes an electronic compass and an accelerator to determine a direction, an angle, and a movement of the seeking help terminal 10. When the photo module 12 of the seeking help terminal 10 captures the image M1, the position identification module 24 generates a first position information. When the seeking help terminal 10 receives the guiding information, the position identification module 24 generates a second position information. The controlling module 20 compares the first position information to the second position information to obtain the projected position L2.

In an alternative embodiment, the guiding information further includes a human voice or text message corresponding to the guiding action of the user of the guiding terminal 50.

It is understood that the present disclosure may be embodied in other forms without departing from the spirit thereof Thus, the present examples and embodiments are to be considered in all respects as illustrative and not restrictive, and the disclosure is not to be limited to the details given herein.

What is claimed is:

1. A remote guiding system, comprising:
a seeking help terminal comprising:
a photo module configured to capture an image corresponding to an object in the vicinity of the seeking help terminal; and
a transmission module configured to transmit the image;
a guiding terminal comprising:
a projecting module configured to receive the image and project the image to an object in the vicinity of the guiding terminal to form a projection picture corresponding to the object in the vicinity of the seeking help terminal;
a photo module configured to capture a picture of a guiding action provided by a person in response to the projection picture;
an image identification module configured to identify the guiding action to obtain a position where the guiding action is pointed to and generate a guiding information according to the position; and
a transmission module configured to transmit the guiding information to the seeking help terminal;
the seeking help terminal further comprising:
a visible laser module configured to project a visible laser; and
a controlling module configured to control the visible laser module project the visible laser on the object in the vicinity of the seeking help terminal according to the guiding information.

2. The remote guiding system as claimed in claim 1, wherein the image identification module obtains a guiding picture from the picture of the guiding action corresponding to an object in the vicinity of the seeking help terminal and identifies the guiding action according to the guiding picture.

3. The remote guiding system as claimed in claim 2, wherein the guiding information comprises the guiding picture and the position.

4. The remote guiding system as claimed in claim 2, wherein, the photo module of the seeking help terminal captures a current image and compares the current picture with the guiding picture of the guiding information to obtain a projected position on the object in the vicinity of the seeking help terminal.

5. The remote guiding system as claimed in claim 3, wherein the position is represented by coordinates in the guiding picture.

6. The remote guiding system as claimed in claim 1, wherein the guiding information comprises the position, the seeking help terminal further includes a position identification module, the position identification module is configured to identify a position of the seeking help terminal.

7. The remote guiding system as claimed in claim 6, wherein when the photo module of the seeking help terminal captures the image, the position identification module generates a first position information, when the seeking help terminal receives the guiding information, the position identification module generates a second first position information.

8. The remote guiding system as claimed in claim 7, wherein , the controlling module compares the first position information to the second position information to obtain a projected position on the object in the vicinity of the seeking help terminal according to a comparison result and controls the visible laser module to highlight the projected position.

9. A guiding terminal configured to guide a seeking help terminal comprising:
a projecting module configured to receive an image in the vicinity of the seeking help terminal transmitted from the seeking help terminal and project the image to an object in the vicinity of the guiding terminal to form a projection picture corresponding to the object in the vicinity of the seeking help terminal;
a photo module configured to capture a picture of a guiding action provided by a person in respond to the projection picture;
an image identification module configured to identify the guiding action to obtain a position to which the guiding action is pointed to and generate a guiding information according to the position; and
a transmission module configured to transmit the guiding information to the seeking help terminal.

10. The guiding terminal as claimed in claim 9, wherein the image identification module obtains a guiding picture from the picture of the guiding action corresponding to an object in the vicinity of the seeking help terminal, the guiding information comprises the guiding picture and the position.

11. The guiding terminal as claimed in claim 10, wherein the position is represented by coordinates in the guiding picture.

12. A seeking help terminal comprising:
a photo module configured to capture an image corresponding to an object in the vicinity of the seeking help terminal;
a transmission module configured to transmit the image to a guiding terminal;
a visible laser module configured to project a visible laser; and
a controlling module configured to control the visible laser module to project the visible laser on the object in the vicinity of the seeking help terminal according to guiding information transmitted from the guiding terminal and correlated with the image.

13. The seeking help terminal as claimed in claim 12, wherein the guiding information comprises a guiding picture and a position.

14. The seeking help terminal as claimed in claim 13, wherein the controlling module obtains the current picture from a new image captured by the photo module and compares the current picture to the guiding picture to obtain a projected position on the object in the vicinity of the seeking help terminal according to a comparison result and controls the visible laser module to highlight the projected position.

15. The seeking help terminal as claimed in claim 14, wherein the position is represented by coordinates in the guiding picture.
